(19) United States
(12) Patent Application Publication
(10) Pub. No.: US 2006/0223950 A1
(43) Pub. Date: Oct. 5, 2006

(54) Process for enhancing the melt strength of polypropylene

(75) Inventors: Lambertus Gerhardus Johannus Olde Hanter, Weerselo (NL); Ludwig Eisenhuth, Obernburg (DE); Arie Jacob De Hoog, Ugchelen (DE); Peter Schneider, Emmerich (DE); Wasil Maslow, Deventer (DE)

Correspondence Address: OLIFF & BERRIDGE, PLC, P.O. BOX 19928, ALEXANDRIA, VA, 22320, US

(73) Assignee: Flexsys B.V., Deventer (NL)

(21) Appl. No.: 10/568,977

(22) PCT Filed: Aug. 18, 2004
(86) PCT No.: PCT/EP04/09297

§ 371 Date: Mar. 27, 2006

Related U.S. Application Data
(60) Provisional application No. 60/506,286, filed on Sep. 26, 2003.

(30) Foreign Application Priority Data
Aug. 27, 2003 (EP) 03077671.0

(51) Int. Cl. C08F 10/00

(52) U.S. Cl. 525/333.7; 525/375

(57) ABSTRACT

A process for enhancing the melt strength of polypropylene includes the steps of: mixing the polypropylene with at least 0.1-8 wt. % of an oligomer of maleimide or a derivative thereof, based on the amount of polypropylene, completely or substantially in the absence of peroxide; reacting the polypropylene and oligomer of maleimide or a derivative thereof at a temperature between 150° C. and 300° C.

The invention relates to a process for enhancing the melt strength of polypropylene (PP), to a composition for said process, to polypropylene with enhanced melt strength, and to the use of said composition of polypropylene for making an article.

Processes for enhancing the melt strength of PP are known. For instance in WO 99/27007 PP is mixed with at least a peroxydicarbonate to give PP with enhanced melt strength. This method has the disadvantage that peroxide compounds are required. Peroxides generally unfavorably affect the molecular weight of the starting PP by cleaving the polymer chains. Furthermore, the use of peroxides is hampered by serious safety risks, particularly by the explosion risk. Other references using peroxide initiators are EP 907677 and JP 60055012. The latter reference, moreover, discloses an adhesive compound further comprising a hydroxy group-containing organic compound, whereas no enhanced melt strengths are reported.

In US 2003/0092816 enhanced melt strength is obtained by making a PP composition with smectic clay that has been ion-exchanged and intercalated with a quaternary ammonium compound and a PP grafted with an ethylenically unsaturated carboxylic acid. Such compositions with modified clays and grafted polymers are not always optimal for any application.

In German patent application DE 19500426 the problem is addressed of using peroxide initiators, indicating the occurrence of chain cleavage on using peroxides. At the same time this reference refers to WO 90/13582, wherein attempts have been described to avoid chain cleavage by minimizing the amount of peroxide. However, in WO 90/13582 it was found that the yield of maleation of polypropylene is restricted when using low amounts of peroxide. For that reason DE 19500426, as well as WO 90/13582, still makes use of significant amounts of peroxide, i.e. according to the examples of DE 19500426 about 0.2%, but prevents the chain cleavage by using a third component, particularly pentaerythritoltriacrylate, in the preparation of grafted copolymers. Such addition may affect the properties of the grafted polymer, and moreover grafted polymers are not always optimal.

To alleviate to above disadvantages there is a need for a simple extrusion process for making PP with enhanced melt strength, which is free, or at least substantially free, from peroxides and also from hydroxy group-containing organic compounds.

To this end, the present invention provides a process for enhancing the melt strength of polypropylene, without grafting the PP, comprising the steps of:

mixing the polypropylene with at least 0.1-8 wt. % of an oligomer of maleimide or a derivative thereof, based on the amount of polypropylene, completely or substantially in the absence of peroxide;

reacting said polypropylene and oligomer of maleimide or a derivative thereof at a temperature between 150° C. and 300° C.

The terms “substantially free” and “substantially in the absence” mean that less than 0.01 wt. % of the indicated component is present in the composition (based on the total weight of the composition). Preferably, such components are totally absent. The product obtained is a composition comprising PP and oligo- and/or polymers of maleimide, wherein PP is not grafted by the maleimide, thereby usually leading to much higher melt strengths than obtained with grafted PP. This novel method of making novel compositions have that advantage that peroxides are not longer necessary, thereby preventing chain cleavage of the PP.

In another embodiment of this invention the process for enhancing the melt strength of polypropylene comprising a step wherein the oligomer of maleimide or a derivative thereof is prepared in situ by mixing the polypropylene with maleimide monomer or a derivative thereof and a base.

The term “polypropylene” (PP) refers to polymers or mixtures of polymers containing at least 50% by weight of polymerized propylene. Polymerization catalysts may be Ziegler-Natta, metallocene, or other types giving stereospecific polymerization of propylene. Use may be made in this connection of homopolymers of propylene; random, alternating, or block copolymers; or random, alternating, or block terpolymers of propylene and another olefin. Generally, a propylene copolymer or terpolymer will contain one or more other olefins, such as ethylene, butene, pentene, hexene, heptene, or octene, but it may also comprise other olefinically unsaturated monomers or combinations of these, such as acrylates, styrene, styrene derivatives, acrylonitrile, vinyl acetate, vinylidene chloride, and vinyl chloride.

It is preferred here to restrict the content of olefins other than propylene to 30% by weight of the copolymer. Especially suited are homopolymers of propylene, copolymers of propylene and ethylene or mixtures of polypropylene and polyethylene containing not more than 10% by weight of polymerized ethylene.

The melting point of normally solid commercially available PP is about 160-170° C. The melting point of propylene copolymers and tercopolymers in general can be lower. The process of the invention preferably is carried out at a temperature in the range of from 150 to 300° C., more preferably from 160 to 250° C., and most preferably from 170 to 225° C.

The molecular weight of the PP used can be selected from a wide range. Indicative of the molecular weight is the melt flow index (MFI). Use may be made of a PP having a MFI from 0.1 to 1000 g/10 min (230° C., 21.6 N). Preferably, use is made of a PP having a MFI from 0.5 to 250 g/10 min.

The process according to the present invention is suitably carried out in melt mixing equipment known to a person skilled in the art. Preferably, an extruder or a kneader is used. More preferably, use is made of a single or twin-screw extruder. An internal mixer such as a Banbury mixer optionally coupled to an extruder may also be used.

The term “maleimide (derivative)” as herein used include maleimide, maleimide derivatives, and oligomers thereof. The maleimide (derivative) may be mixed first with the PP and then the mixture may be extruded. Alternatively, the maleimide (derivative) may be added to the extruder already containing the PP by injection or spraying, or may be added together with the PP. This is especially preferred when oligomers are used. When monomers are used the maleimide (derivative) is added together with the base. It is preferred to introduce a solid or semi-solid maleimide (derivative) together with the PP into the extruder, for example, by using a feeder. The temperature setting of the extruder should allow the PP to melt, i.e. above 150° C. The screw speed typically is from about 25 to 500 rpm. According to the invention the preferred maleimide (derivative) is derived from biscitraconic acid or the oligomer thereof. The quantity of maleimide (derivative) is 0.1-8 wt. % based on the weight of PP. Preferably, the quantity of maleimide (derivative) is 1-4 wt. %.

The base may be any base that is known in the art. Particularly useful bases are tertiary amino bases, for instance bridged alicyclic nitrogen bases such as 3-quinuclidinol, 1,8-diazabicyclo[5,4,0]undecene; or 1,4-diazabicyclo[2,2,2]octane (commercially known as Dabco®), substituted imidazoles such as 2-ethyl-4-methylimidazole, substituted pyridines such as 4-(dimethylamino)pyridine, guanidine and derivative thereof, inorganic bases such as sodium hydroxide, and trialkylamines. Practical quantities are 1 to 100 wt. % based on the weight of maleimide (derivative).

Normal residence time in the extruder is 15 sec to 30 min. The longer residence times can be achieved by using additional static mixers, and the like.

The extruded strand may be further processed as known to one of ordinary skill in the art; Normally, the extruded strand is fed through a water bath and granulated using a granulator. Alternatively, the extruded modified PP is formed directly into a desired end product.

It is preferred to carry out the process of the present invention in an atmosphere of an inert gas, such as nitrogen or argon. Preferably, nitrogen is used.

Solid as well as liquid maleimide (derivative) may be used in the process according to the present invention. A solution of a maleimide (derivative) in an inert solvent, such as isododecane, or in the form of frozen flakes, may also be used. Suitable inert solvents are known to one skilled in the art. It is preferred to use a solid maleimide (derivative) in the form of, for example, flakes, finely divided particles (powder), or a liquid maleimide (derivative).

Optionally, the modified PP may be purified, modified, or molded in one or more process steps, prior to its final processing. Thus, there may be further modification using another polymer or monomer in order to enhance the end product's compatibility with other materials. Alternatively, the modified PP may be degraded or, on the contrary, cross-linked slightly, to increase its processability and/or applicability. The modified PP according to the invention has a melt strength that is at least 1.5, preferably 1.8 times higher than the melt strength of the starting not-modified PP. Generally, to achieve the desired end conventional adjuvants in an amount known to one skilled in the art, such as antioxidants, UV-stabilizers, lubricants, antidegradants, foaming agents, nucleating agents, fillers, pigments and/or antistatic agents are added to the PP. These adjuvants can be added to the PP before as well as during or after the modifying step according to the invention. For example, a blowing agent can be added or gas can be injected into the extruder before, during or after the modification, in order to produce foamed PP.

The PP obtained by the invention process does not show a substantial difference in weight average molecular weight, indicating that cleavage of the polymer chain does not occur. Only oligomers of maleimide (derivative) or mixtures thereof (or their precursors, i.e., mixtures of maleimide (derivative) monomers with bases) have been found to give the desired enhanced melt strength in the process of the present invention. Oligomers of maleimide (derivative) or mixtures thereof can for instance be prepared by anionic or radical polymerization of maleimide (derivatives). It was found that such oligomers could be directly added tot the PP in the melt phase, or that such oligomers could in situ be prepared by the addition of maleimide (derivative) monomers in the presence of a base to the PP, without leading to modified polypropylenes of significant different melt strength.

The PP obtained using the process according to the present invention may be processed into an end product without any further adaptations if so desired. The modified PP can be processed into the desired end product, such as foams, fibers, or sheets in all kinds of ways known to the skilled person, with the processing conditions generally being dependent on the material and equipment employed, such as, for example, by foaming, foam molding, extrusion, injection molding, blow molding, extrusion coating, profile extrusion, or thermoforming.

The invention is illustrated by the following Examples. The following materials and methods are employed in the Examples:

Polypropylene: PP HC001A-B1, ex Borealis, Austria

Flexlink®: meta-xylylene biscitraconimide ex Flexsys, USA

Dabco®: 1,4-diazabicyclo[2,2,2]octane, ex Tosoh, Japan

Procedure A

Mixing procedure:

The maleimide compound Flexlink® and Dabco® were added to polypropylene powder in a bucket and tumble-mixed by hand for 5 minutes at room temperature. Compounds were extruded immediately after mixing.

Compounding procedure:

All compounds were melt-modified by extrusion in a Haake “TW100” twin screw extruder with intensive mixing screws attached to a Haake “Rheocord System 40”. During the experiment nitrogen was passed in counterflow from the hopper up through the feeder.

The extruder comprised a barrel housing four consecutive temperature chambers, wherein the first chamber had a temperature of 180° C., the second 180° C., the third 180° C., and the fourth chamber 190° C. The screw speed was 80 rpm. The extruded strand was fed through a water bath and granulated with an Automatic “ASG5” granulator.

Test procedures:

MFI (Melt Flow Index), characterizing the flow behavior of a PP melt, was measured with a Goettfert Melt Indexer (model MP-D) according to DIN 53735 and ASTM 1238 (230° C., 21.6 N load).

Melt strength, i.e. the ability of a melt of PP to withstand a tensile elongation or stretching without breaking, was measured using one of two instruments:

Instrument 1: a Goettfert Rheotens attached to a Goettfert Rheograph 2001 capillary rheometer (200° C., die geometry 30/1 mm, initial speed 20 mm/s, acceleration 1.2 mm/s², strand length 100 mm).

Instrument 2: a Goettfert 71.97 (200° C., die geometry 30/2 mm, initial speed 18.5 mm/s, acceleration 30 mm/s², strand length 100 mm).

### EXAMPLE 1

1000 g of polypropylene powder were mixed with 30 g of Flexlink® and 2 g of Dabco® as described above. The mixture was melt extruded in a Haake “TW100” twin screw extruder under the conditions given above.

The obtained product had a MFI of 2.2 g/10 min and a melt strength of 42 cN (200° C., acceleration 30 mm/s²). In comparison the non-modified polypropylene used has an MFI of 7.6 g/10 min and a melt strength of 22 cN (measured on Instrument 2).

### EXAMPLE 2

Example 1 was repeated, but 20 g of Flexlink® and 5 g of Dabco® were used. The product had a melt flow of 2.1 g/10 min and a melt strength of 40 cN (measured on Instrument 2).

### EXAMPLE 3

40 g of Flexlink® and 8 g of Dabco® were dissolved in 200 ml of toluene and refluxed for 1 h. The toluene was removed and a mixture of oligomers was obtained wherein part of the C—C double bonds of the Flexlink® was changed by reaction (according to NMR analysis). 30 g of the thus obtained product were mixed with polypropylene powder as described above and melt extruded as in Example 1.

The product was clear but slightly brownish and had an MFI of 2.1 g/10 min and a melt strength of 42 cN (measured on Instrument 1).

### EXAMPLE 4

Example 1 was repeated, but 50 g of Flexlink® were used.

The product had a MFI of 2.3 g/10 min and a melt strength of 13.5 cN (measured on Instrument 1). The not modified PP used had a MFI of 7.6 g/10 min and a melt strength of 3.4 cN.

### EXAMPLE 5

Example 1 was repeated, but 30 g of meta-phenylene bismaleimide were used instead of Flexlink®, and no Dabco® was used.

The modified PP made in this way had a MFI of 0.9 g/10 min and a melt strength of 11 cN (measured on Instrument 1).

1-8. (canceled)

9. A process for enhancing the melt strength of polypropylene comprising the steps of:
mixing 100 parts per weight (ppw) of the polypropylene with at least 0.1-8 ppw of an oligomer of maleimide or an oligomer of a maleimide derivative, in the absence of peroxide or in the presence of less than 0.01 ppw of peroxide;
reacting said polypropylene and oligomer of maleimide or oligomer of a maleimide derivative at a temperature between 150° C. and 300° C.

10. The process according to claim 9 wherein the oligomer of maleimide or the oligomer of a maleimide derivative is prepared in situ by mixing the polypropylene with maleimide monomer or a derivative thereof and a base.

11. The process according to claim 9 wherein the oligomer of a maleimide derivative is derived from biscitraconic acid.

12. The process according to claim 10 wherein the maleimide derivative is derived from biscitraconic acid and the base is 1,4-diazabicyclo[2,2,2]octane.

13. A composition, which is free from peroxide or contains less than 0.01 ppw of peroxide, comprising 100 ppw of polypropylene and 0.1-8 ppw of an oligomer of maleimide or an oligomer of a maleimide derivative, or a mixture of 0.1-8 ppw of a monomer of maleimide or a derivative thereof and a base.

14. The composition of claim 13 wherein the maleimide derivative is derived from biscitraconic acid and the base is 1,4-diazabicyclo[2,2,2]octane.

15. A polypropylene which is free from peroxide or contains less than 0.01 ppw of peroxide, obtainable from the composition of claim 13 with enhanced melt strength, which is at least 1.5 times higher than the melt strength of the corresponding non-modified polypropylene.

16. A polypropylene which is free from peroxide or contains less than 0.01 ppw of peroxide, obtainable from the composition of claim 14 with enhanced melt strength, which is at least 1.5 times higher than the melt strength of the corresponding non-modified polypropylene.

17. A method of making a foam, fiber, or sheet, comprising using the composition of claim 13.

18. A method of making a foam, fiber, or sheet, comprising using the composition of claim 14.

19. A method of making a foam, fiber, or sheet, comprising using the polypropylene of claim 15.
